(19) United States
(12) Patent Application Publication
(10) Pub. No.: US 2026/0257588 A1
(43) Pub. Date: Sep. 3, 2026

(54) Seat Rail System

(71) Applicants: HYUNDAI MOTOR COMPANY, Seoul (KR); KIA CORPORATION, Seoul (KR); DAE WON SAN UP CO., LTD, Ansan-si (KR)

(72) Inventors: Tae Jun Kwon, Hwaseong-si (KR); Sang-Soo Lee, Hwaseong-si (KR); Taesu Kim, Hwaseong-si (KR); Min Seok Kim, Hwaseong-si (KR); Hyun Ko, Hwaseong-si (KR); Byung Yong Choi, Hwaseong-si (KR); Sun Ho Hur, Seoul (KR); Sang Yong Koo, Incheon (KR); Hyun Deok Choi, Siheung-si (KR)

(73) Assignees: HYUNDAI MOTOR COMPANY, Seoul (KR); KIA CORPORATION, Seoul (KR); DAE WON SAN UP CO., LTD, Ansan-si (KR)

(21) Appl. No.: 19/400,903

(22) Filed: Nov. 25, 2025

(30) Foreign Application Priority Data
Feb. 28, 2025 (KR) 10-2025-0027014

(51) Int. Cl. B60N 2/02; B60N 2/07; B60R 16/03

(52) U.S. Cl. CPC B60N 2/02253; B60N 2/0722; B60R 16/03

(57) ABSTRACT

A seat rail system includes a first lower rail portion and a second lower rail portion, as well as a first upper rail portion and a second upper rail portion movably mounted on the first lower rail portion and the second lower rail portion, respectively. The seat rail system further includes busbars, where each of the busbars is surrounded by an insulator and mounted on the first lower rail portion and the second lower rail portion, respectively. The seat rail system also includes a brush assembly including brushes, where each of the brushes is mounted on the first upper rail portion and the second upper rail portion, respectively, and configured to contact a respective busbar of the busbars.

### CROSS-REFERENCE TO RELATED APPLICATION

This application claims priority to and the benefit of Korean Patent Application No. 10-2025-0027014 filed with the Korean Intellectual Property Office on Feb. 28, 2025, the entire contents of which are incorporated herein by reference.

### BACKGROUND

### Technical Field

The present disclosure relates to a seat rail system, and more particularly, the present disclosure relates to a seat rail system capable of stably and safely supplying power.

### Description of the Related Art

Typically, a slide device includes a straight bar-shaped lower rail that is elongated in the forward and backward direction of a vehicle to allow the seat to move forward or backward, and a carriage that may move along the lower rail.

Typically, the lower rail is formed entirely of straight sections so that the seats may move in a straight line.

However, for example, in the case of vehicle seats, a lower rail with curved sections is applied to prevent the rear wheel house from protruding into the interior space.

The wiring used to supply power to operate this seat rail system has limitations in seat motion (stroke), and the wiring is exposed to occupants during long stroke movements, which may cause safety issues such as injury to occupants or short circuits.

In a typical seat rail system, integrated wiring is applied to the space between the rails, with positive (+) and negative (−) power integrated, and a chain is sometimes applied to prevent the wiring from being damaged by external factors. As a result, the weight and cost increase, and the stroke may be limited due to the wiring characteristics.

The above information contained in this Background section is only to enhance the understanding of the background of the disclosure. Therefore, the Background section may contain information that does not form the prior art that is already known to a person of ordinary skill in the art to which this technology belongs.

### SUMMARY

An aspect of the present disclosure is to provide a seat rail system that may be supplied with power in a stable and safe manner.

Technical problems to be solved by the present disclosure are not limited to the above-mentioned technical problems, and other technical problems, which are not mentioned above, may be clearly understood from the following descriptions by those having ordinary skill in the art to which the present disclosure pertains.

The present disclosure has been made in an effort to solve the above-described problems associated with the prior art. The present disclosure provides a seat rail system.

The seat rail system may include a first lower rail portion and a second lower rail portion, as well as a first upper rail portion and a second upper rail portion movably mounted on the first lower rail portion and the second lower rail portion, respectively. The seat rail system may also include busbars, where each of the busbars is surrounded by an insulator and mounted on the first lower rail portion and the second lower rail portion, respectively. The seat rail system may further include a brush assembly including brushes, where each of the brushes is mounted on the first upper rail portion and the second upper rail portion, respectively, and configured to contact the busbars.

Polarities of the power supplied to the busbars mounted on the first lower rail portion and the second lower rail portion may be different.

The insulator may include an insulator elastic part that pushes the busbars toward the brushes.

The brushes may be mounted to rotate relative to the brush assembly to be in constant contact with the busbars.

The brushes may include a front brush mounted to allow rotation relative to the brush assembly, and a rear brush mounted separately from the front brush and capable of rotation relative to the brush assembly.

The brushes may include a brush contact portion in contact with the busbars, and a brush body supported by a brush elastic part so that the brush contact portion is in close contact with the busbars.

The brush assembly may include a brush bracket, a brush case mounted on the brush bracket and in which the brushes are rotatably mounted, and a brush elastic part that elastically supports the brushes.

The brush elastic part may include at least one or more compression spring.

The brush case may have a cable hole formed through which a cable electrically connected to the brushes passes.

The seat rail system may further include a slide rail mounted on the first lower rail portion and the second lower rail portion, respectively, and a slide bushing mounted on the brush assembly to move along the slide rail.

The brush assembly may further include a slide housing on which the slide bushing is mounted.

The brush assembly may include a brush bracket on which the brush case is mounted, and an upper bracket plate rotatably mounted relative to the upper portion of the brush bracket.

The brush assembly may further include a brush carrier mounted on the upper bracket plate.

The seat rail system may further include a brush connect bracket configured to connect the upper bracket plate on the first upper rail portion and the upper bracket plate on the second upper rail portion.

The upper bracket plate and the brush connect bracket may be configured to allow relative rotation.

The seat rail system may further include a connecting pin connecting a respective upper bracket plate and the brush connect bracket, and the brush connect bracket may have a hole and a slit formed into which the connecting pin is inserted.

The first lower rail portion and the second lower rail portion may include at least one or more curved sections.

The seat rail system may further include a seat assembly mounted on the first upper rail portion and the second upper rail portion, and the seat assembly may be configured to move along with the movement of the first upper rail portion and the second upper rail portion. In other words, a movement of the seat assembly may correspond to the movement of the first upper rail portion and the second upper rail portion.

The seat rail system may further include an insulator housing, where the insulator is configured to be inserted into the insulator housing, and an insulator housing protrusion formed in the insulator housing. The seat rail system may also include an insulator protrusion formed in the insulator and pressed into the insulator housing protrusion preventing separation of the insulator and the inner lower rail.

The insulator protrusion may elastically support the busbars and may be formed at an end of the insulator to prevent separation of the busbars and the insulator.

In an embodiment of the seat rail system, power may be supplied stably and safely.

In an embodiment of the seat rail system, power may be supplied stably and safely regardless of the length of the rail.

In an embodiment of the seat rail system, power may be supplied stably and safely even in a rail including a curved section.

The above and other features of the disclosure are discussed below. The effects obtained by the present disclosure are not limited to the aforementioned effects, and other effects, which are not mentioned above, should be clearly understood by those having ordinary skill in the art from the following description.

### BRIEF DESCRIPTION OF THE DRAWINGS

These drawings are intended for reference in explaining embodiments of the present disclosure, and therefore, the technical ideas of the present disclosure should not be construed as being limited to the accompanying drawings.

FIG. 1 is a top plan view of a seat rail system according to an embodiment.

FIG. 2 is a cross-sectional view along line II-II of FIG. 1.

FIG. 3 is a partial perspective view of a seat rail system according to an embodiment.

FIG. 4 is a perspective view of a brush assembly of a seat rail system according to an embodiment.

FIG. 5 is a partial perspective view of a seat rail system according to an embodiment.

FIG. 6 is an exploded perspective view of a slide bushing and a slide housing of a seat rail system according to an embodiment.

FIG. 7 and FIG. 8 are partially exploded perspective views of a seat rail system according to an embodiment.

FIG. 9 is an exploded perspective view of a brush assembly of a seat rail system according to an embodiment.

FIG. 10 is a partial cross-sectional view of a seat rail system according to an embodiment.

FIG. 11 is a drawing explaining operation of a seat rail system according to an embodiment.

FIG. 12 is a partial top plan view of a seat rail system according to an embodiment.

### DESCRIPTION OF SYMBOLS

10: seat rail system 12: rail
20: lower rail 22: inner lower rail
24: outer lower rail 30: straight section
32: curve section 40: slide rail
50: first lower rail portion 52: second lower rail portion
60: busbar 62: insulator housing
64: insulator housing protrusion 70: insulator
72: insulator elastic part 74, 75: insulator protrusion
80: upper rail 82: first upper rail portion
84: second upper rail portion 90: brush assembly
92: brush 94: front brush
96: rear brush 98: brush contact portion
100: brush body 101: brush hole
110: brush bracket 120: brush case
121; front case 122; rear case
124: cable hole 130: brush elastic part
132: bracket fastening hole 140: cable
150: slide bushing 152: slide housing
160: upper bracket plate 161: bracket plate hinge hole
162: brush assembly hinge hole 164: hinge pin
165: carrier coupling hole 170: brush carrier
172: carrier fastener 180: brush connect bracket
181; connect bracket connection hole
182: connecting pin
184: hole 186: slit
190: seat assembly 192: floor
194: rack gear 196: seat rail

It should be understood that the appended drawings are not necessarily drawn to scale, but should be understood as presenting rather simplified representation of various features illustrative of the basic principles of the disclosure. The specific design features of the present disclosure as disclosed herein, including, for example, specific dimensions, orientations, locations, and shapes, are determined in part by the particular intended application and use environment.

In the figures, reference numbers refer to the same or equivalent parts of the present disclosure throughout the several figures of the drawings.

### DETAILED DESCRIPTION

The present disclosure is described more fully hereinafter with reference to the accompanying drawings, in which embodiments of the disclosure are shown. As those having ordinary skill in the art should realize, the described embodiments may be modified in various different ways, all without departing from the spirit or scope of the present disclosure.

In order to clearly explain the present disclosure, parts irrelevant to the description are omitted, and the same reference numerals are used for identical or similar components throughout the specification.

The size and thickness of each component shown in the drawings are arbitrarily shown for better understanding and ease of description, and the present disclosure is not necessarily limited to what is shown in the drawings, and the thickness is shown by enlarging the component and thickness thereof to clearly express various parts and regions.

Throughout the specification, when a part is said to include a component, this does not mean that it excludes other components, but rather that it may include other components, unless otherwise specifically stated.

Additionally, terms such as “means”, “part”, “unit”, etc., described in the specification mean a comprehensive unit that performs at least one function or operation. When a component, unit, module, controller, device, element, part, apparatus, or the like of the present disclosure is described as having a purpose or performing an operation, function, or the like, the component, unit, module, controller, device, element, part, apparatus, or the like should be considered herein as being “configured to” meet that purpose or to perform that operation or function. Each component, unit, module, controller, device, element, part, apparatus, and the like may separately embody or be included with a processor and a memory, such as a non-transitory computer readable media, as part of the apparatus.

When we say that a part, such as a layer, membrane, region, or plate, is “on top of” another part, this includes not only cases where it is directly on top of the other part, but also cases where there are other parts in between.

In contrast, when an element is referred to as being “directly on” another element, there are no intervening elements present.

The terms “vehicle”, “car”, “vehicle of”, “vehicular” or other similar terms used in this specification include passenger vehicles including sports utility vehicles (SUVs), buses, trucks, various commercial vehicles, ships including various types of boats and vessels, aircraft and the like, as well as hybrid vehicles, electric vehicles, plug-in hybrid electric vehicles, hydrogen fuel vehicles and other alternative fuel (e.g., fuel obtained from resources other than petroleum) vehicles.

An embodiment of the present disclosure is hereinafter described in detail with reference to the accompanying drawings.

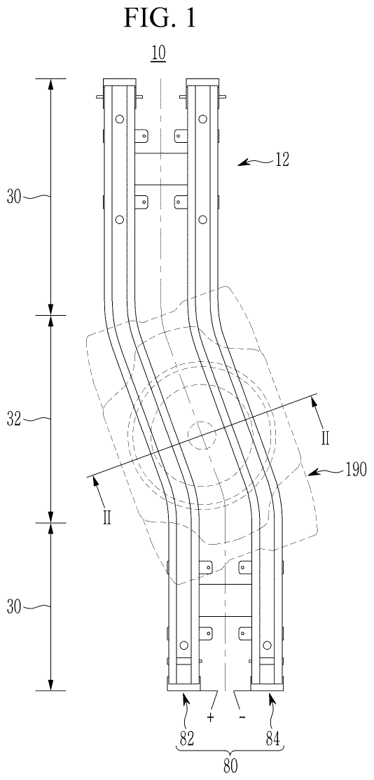

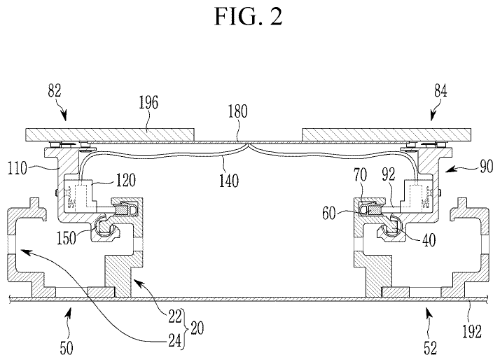

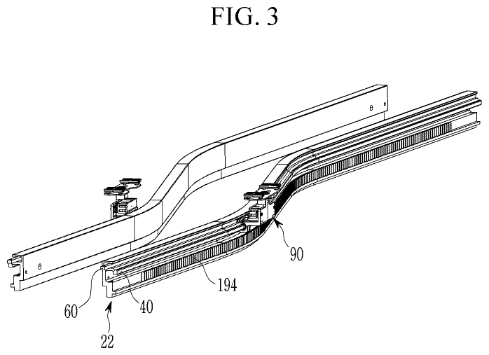

FIG. 1 is a top plan view of a seat rail system 10 according to an embodiment, FIG. 2 is a cross-sectional view along line II-II of FIG. 1, and FIG. 3 is a partial perspective view of a seat rail system 10 according to an embodiment.

Referring to FIG. 1 to FIG. 3, a seat rail system 10 according to an embodiment includes a rail 12, on which a seat assembly 190 is provided to be movable.

The seat rail system 10 according to an embodiment is intended to stably supply electric power to the seat assembly 190 that is movably installed on the rail 12.

The rail 12 may be placed on a floor 192. The floor 192 may be, for example, a variety of floors applied to a vehicle body, an airplane, a ship, or the like.

The rail 12 may take various forms (e.g., shapes), including straight and curved sections.

For example, the rail 12 may include a straight section 30 and a curved section 32. In some examples, the rail 12 may include more than one straight section 30 and more than one curved section 32.

The rail 12 may include a lower rail 20 mounted on the floor 192 and an upper rail 80 movably provided on the lower rail 20.

The upper rail 80 is configured to move on the lower rail 20, and the seat assembly 190 is mounted on the upper rail 80 and may move along with the movement of the upper rail 80.

The lower rail 20 may include inner lower rails 22 arranged parallel to each other and outer lower rails 24 arranged on the outer side of the inner lower rails 22.

The drawing shows a brush assembly 90, which is described later, as mounted on at least one of the inner lower rails 22, but is not limited thereto and may be mounted on at least one of the outer lower rails 24.

The seat rail system 10 according to an embodiment may include a rack gear 194, in which a pinion (not shown) is engaged, and the seat assembly 190 may be moved according to the driving of the pinion within the rack gear 194.

The configuration and operation of these rack gears, pinions, or the like. are known to those having ordinary skilled in the art, so a detailed description is omitted.

The seat rail system 10 according to an embodiment may include a first lower rail portion 50 and a second lower rail portion 52, as well as a first upper rail portion 82 and a second upper rail portion 84 movably mounted on the first lower rail portion 50 and the second lower rail portion 52, respectively. The seat rail system 10 may further include a busbar 60 surrounded by an insulator 70 and mounted on the first lower rail portion 50 and the second lower rail portion 52, respectively.

The first lower rail portion 50 and the second lower rail portion 52 are separated for ease of understanding. Their configurations are the same; however, their shape and mounting position are different.

The seat rail system 10 according to an embodiment may include the brush assembly 90 including brushes 92 mounted on the first upper rail portion 82 and the second upper rail portion 84, respectively, that are configured to contact the busbar 60.

The polarity of the power supplied to the busbar 60 mounted on the first lower rail portion 50 and the second lower rail portion 52, respectively, may be different.

In FIG. 1, the power supplied to the busbar 60 mounted on the first lower rail portion 50 is expressed as the positive (+) pole, and the power supplied to the busbar 60 mounted on the second lower rail portion 52 is expressed as the negative (−) pole. However, the configuration is not limited to this, as it is possible for the power to be supplied in the opposite direction.

Generally, a busbar (or bus bar) is in the form of a metal strip or bar and has sufficient strength.

Therefore, the busbar 60 is applied to the first lower rail portion 50 and the second lower rail portion 52 through which the seat assembly 190 moves to prevent deformation or damage and enable stable supply of power.

The insulator 70 may cover the busbar 60 and block electrical leakage to the lower rail 20.

The first lower rail portion 50 and the second lower rail portion 52 may include at least one or more of the curved section(s) 32.

In other words, as described in FIG. 1, the rail 12 may include the straight section 30 and the curved section 32. The seat rail system 10 according to an embodiment may stably supply electric power even when the seat assembly 190 moves along the curved section 32.

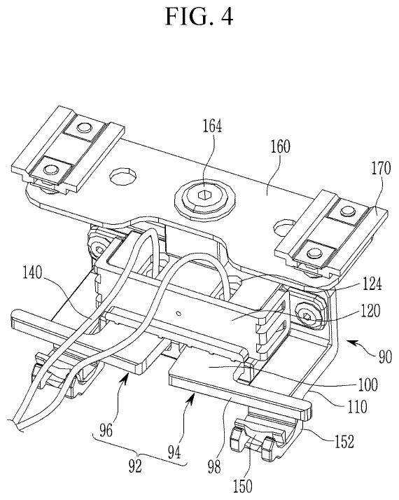

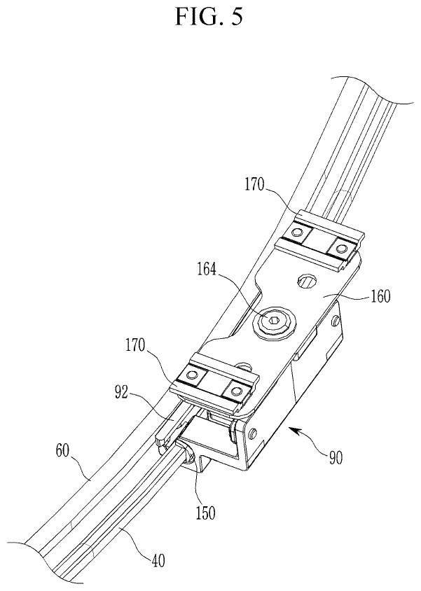

FIG. 4 is a perspective view of a brush assembly 90 of a seat rail system 10 according to an embodiment, and FIG. 5 is a partial perspective view of a seat rail system 10 according to an embodiment.

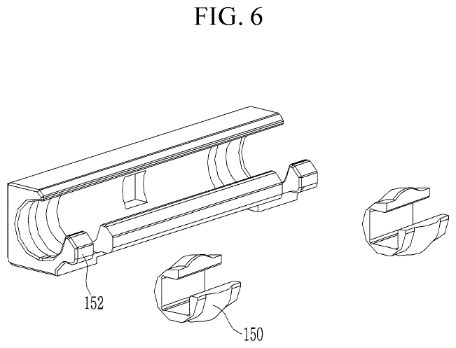

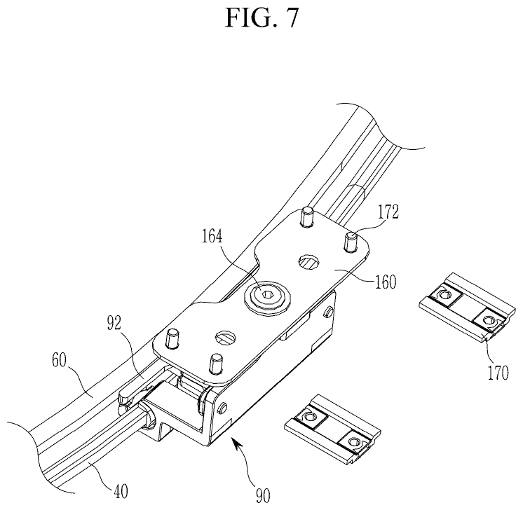

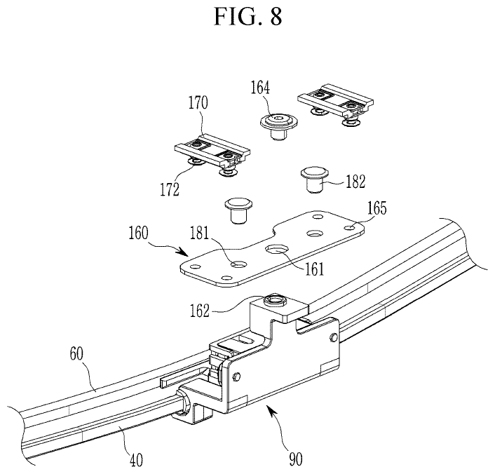

FIG. 6 is an exploded perspective view of a slide bushing 150 and a slide housing 152 of a seat rail system 10 according to an embodiment, and FIG. 7 and FIG. 8 are partially exploded perspective views of a seat rail system 10 according to an embodiment.

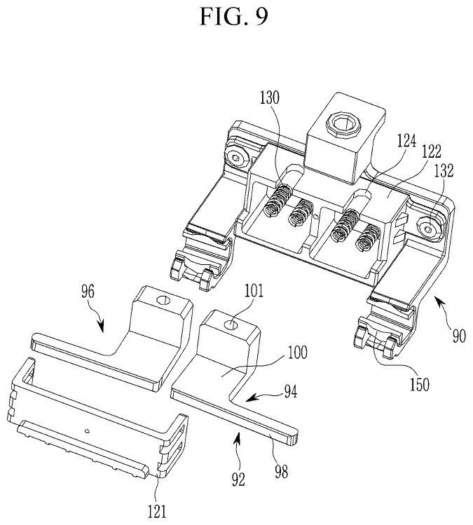

FIG. 9 is an exploded perspective view of a brush assembly 90 of a seat rail system 10 according to an embodiment.

Referring to FIG. 4, the brush 92 may be mounted for relative rotation to the brush assembly 90 to be in constant contact with the busbar 60. Relative rotation means a change in position or rotation of the brush 92 with respect to the brush assembly 90 so that it is in constant contact with the busbar 60, which is explained later.

The brush 92 may include a front brush 94 that is mounted for rotation relative to the brush assembly 90, and a rear brush 96 that is mounted separately from the front brush 94 and for rotation relative to the brush assembly 90.

FIG. 4 shows the front brush 94 and the rear brush 96, but the configuration is not limited thereto. The brush 92 may be mounted in one or more pieces to enable rotation relative to the brush assembly 90.

Additionally, the front brush 94 and the rear brush 96 are named differently for ease of understanding and are not limited to their moving direction or mounting position.

Referring to FIG. 4 and FIG. 9, the brush 92 may include a brush contact portion 98 configured to be in contact with the busbar 60, and a brush body 100 supported by a brush elastic part 130 to bring the brush contact portion 98 into close contact with the busbar 60.

The brush assembly 90 may include a brush bracket 110, a brush case 120 mounted on the brush bracket 110 and on which the brush 92 is rotatably mounted, and the brush elastic part 130 for elastically supporting the brush 92.

The brush case 120 may be mounted to the brush bracket 110 through the bracket fastening hole 132. The brush case 120 includes a front case 121 and a rear case 122, and the brush elastic part 130 may be mounted between the front case 121 and the rear case 122.

The brush elastic part 130 may have various configurations of elasticity that support the brush 92. For example, the brush elastic part 130 may include at least one or more compression springs. When the seat assembly 190 passes the curved section 32, the brush elastic part 130 may push the brush 92 in the direction of the busbar 60 to maintain contact between the brush 92 and the busbar 60. The brush elastic part 130 elastically supports the brush 92 so that the brush 92 may rotate relative to the brush assembly 90.

The brush case 120 may have a cable hole 124 through which a cable 140 electrically connected to the brush 92 passes.

A brush hole 101 is formed in the brush 92, and the cable 140 may be inserted into the brush hole 101.

The power transmitted through the busbar 60 may be stably transmitted to the seat assembly 190 through the brush 92 and the cable 140.

Referring to FIG. 2 to FIG. 6, the seat rail system 10 according to an embodiment may further include a slide rail 40 mounted on the first lower rail portion 50 and the second lower rail portion 52, respectively, and a slide bushing 150 mounted on the brush assembly 90 to move along the slide rail 40.

The slide bushing 150 may move along the slide rail 40, which is mounted on the first lower rail portion 50 and the second lower rail portion 52, respectively, so that the brush assembly 90 may move stably along the first lower rail portion 50 and the second lower rail portion 52.

The brush assembly 90 may further include a slide housing 152 on which the slide bushing 150 is mounted. The slide bushing 150 may be rotatably mounted within the slide housing 152.

The slide housing 152 stably supports the slide bushing 150 to prevent the brush assembly 90 from shaking even when the brush assembly 90 moves along the first lower rail portion 50 and the second lower rail portion 52, thereby enabling stable power supplying without a short circuit of the power supply.

Referring to FIG. 4 to FIG. 8, the brush assembly 90 applicable to the seat rail system 10 according to an embodiment may include an upper bracket plate 160 rotatably mounted on top of the brush bracket 110.

The upper bracket plate 160 may be disposed on the first upper rail portion 82, the second upper rail portion 84, or both the first upper rail portion 82 and the second upper rail portion 84.

A brush assembly hinge hole 162 is formed in the upper portion of the brush assembly 90, a bracket plate hinge hole 161 is formed in the upper bracket plate 160, and a hinge pin 164 is configured to be inserted into the brush assembly hinge hole 162 and the bracket plate hinge hole 161 to enable relative rotation of the upper bracket plate 160.

The brush assembly 90 may further include a brush carrier 170 mounted on the upper bracket plate 160.

For example, a carrier coupling hole 165 is formed in the upper bracket plate 160, and a carrier fastener 172 is engaged in the carrier coupling hole 165 so that the brush carrier 170 may be mounted on the upper bracket plate 160. The brush carrier 170 may support the seat assembly 190.

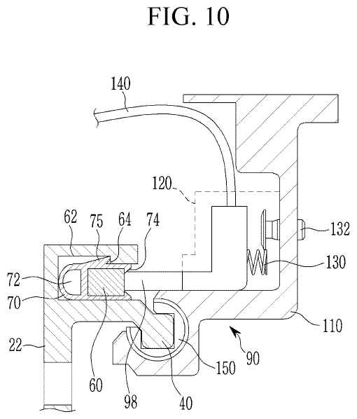

FIG. 10 is a partial cross-sectional view of a seat rail system 10 according to an embodiment.

Referring to FIG. 2 and FIG. 10, the insulator 70 may include an insulator elastic part 72 that pushes the busbar 60 toward the brush 92.

For example, the insulator elastic part 72 is formed of a material having a different elasticity from the insulator 70 and may push the busbar 60 in the direction of the brush 92. The insulator elastic part 72 may be a single space (e.g., specific, restricted space), or the busbar 60 may be pressed into the insulator 70 so that the force pushing the busbar 60 toward the brush 92 is maintained.

For example, an insulator housing 62 may be formed in the inner lower rail 22, and the insulator 70 may be inserted into the insulator housing 62. An insulator housing protrusion 64 may be formed in the insulator housing 62, and an insulator protrusion 75 may be formed in the insulator 70 and pressed into the insulator housing protrusion 64. This configuration prevents separation of the insulator 70 and the inner lower rail 22.

An insulator protrusion 74 that elastically supports the busbar 60 is formed at one end of the insulator 70 to prevent separation of the busbar 60 and the insulator 70.

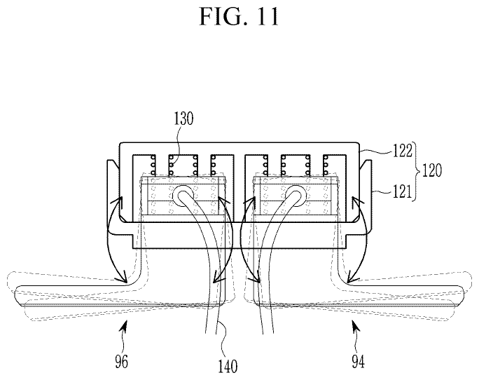

FIG. 11 is a drawing explaining operation of a seat rail system 10 according to an embodiment.

Referring to FIG. 1, FIG. 10 and FIG. 11, the brush elastic part 130 may push the brush 92 in the direction of the busbar 60 to maintain contact between the brush 92 and the busbar 60.

When the seat assembly 190 passes the curved section 32, the brush elastic part 130 also elastically supports the brush 92 so that the brush elastic part 130 may rotate relative to the brush assembly 90, thereby maintaining contact between the brush 92 and the busbar 60. The front brush 94 and the rear brush 96 are separated and may rotate independently, so that contact between the brush 92 and the busbar 60 may be maintained even when the seat assembly 190 passes through the curve section 32.

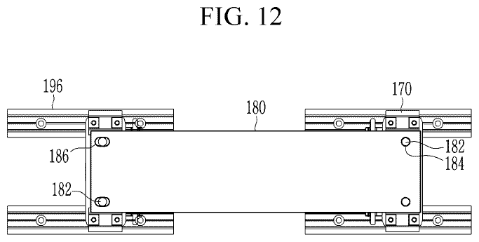

FIG. 12 is a partial top plan view of a seat rail system 10 according to an embodiment.

Referring to FIG. 2, FIG. 4, FIG. 8 and FIG. 12, the seat rail system 10 according to an embodiment may further include a brush connect bracket 180 connecting the upper bracket plate 160 on the first upper rail portion 82 and the upper bracket plate 160 on the second upper rail portion 84.

The upper bracket plate 160 and the brush connect bracket 180 may be connected to enable relative rotation. In other words, the upper bracket plate 160 of the first rail portion 82 and the upper bracket plate 160 on the second upper rail portion 84 may be connected to the brush connect bracket 180.

The seat rail system 10 according to an embodiment further includes a connecting pin 182 connecting the upper bracket plate 160 and the brush connect bracket 180 (e.g., each upper bracket plate 160 and the brush connect bracket 180). A hole 184 and a slit 186 (e.g., into which each of the connecting pins 182 is inserted) may be formed in the brush connect bracket 180.

A connect bracket connection hole 181 is formed in the upper bracket plate 160, and the connecting pin 182 is inserted into the connect bracket connection hole 181 so that the upper bracket plate 160 and the brush connect bracket 180 may be connected.

The brush connect bracket 180 may connect the upper bracket plate 160 on both sides to prevent the upper bracket plate 160 from tilting.

The hole 184 illustrated in FIG. 12 may be formed and connected to, for example, the upper bracket plate 160 on the right side of the drawing, via the connecting pin 182. The slit 186 may be formed and connected to, for example, the upper bracket plate 160 on the left side of the drawing, via the connecting pin 182.

This configuration stably supports the brush assembly 90 even if there is a distance deviation between the first lower rail portion 50 and the second lower rail portion 52, thereby preventing a short circuit of the power supply and enabling stable movement of the seat assembly 190.

A seat rail 196 is mounted on the brush carrier 170, and the seat assembly 190 may be coupled to the seat rail 196.

As explained above, according to the seat rail system 10, integrated wiring is not applied, and separate busbars are applied to suppress problems (e.g., injury or short circuit) due to exposure of wiring.

Additionally, the seat rail system 10 according to disclosed embodiment does not have integrated wiring, so the stroke is not limited.

According to the seat rail system 10, a chain for wiring protection is not applied, so the weight of the vehicle may be reduced, and the production cost may be lowered.

According to the seat rail system 10, the contact between the busbar 60 and the brush 92 is maintained so that power may be supplied stably and safely.

In addition, according to the seat rail system 10, power may be supplied stably and safely even in a rail 12 including a curve section 32.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A seat rail system comprising:
a first lower rail portion and a second lower rail portion;
a first upper rail portion and a second upper rail portion movably mounted on the first lower rail portion and the second lower rail portion, respectively;
busbars, wherein each of the busbars is surrounded by an insulator and mounted on the first lower rail portion and the second lower rail portion, respectively; and
a brush assembly including brushes, wherein each of the brushes is mounted on the first upper rail portion and the second upper rail portion, respectively, and configured to contact a respective busbar of the busbars.

2. The seat rail system of claim 1, wherein polarities of the power supplied to the busbars mounted on the first lower rail portion and the second lower rail portion are different.

3. The seat rail system of claim 1, wherein the insulator comprises
an insulator elastic part that pushes a respective busbar toward a respective brush.

4. The seat rail system of claim 1, wherein
the brushes are mounted to rotate relative to the brush assembly to be in constant contact with the busbars.

5. The seat rail system of claim 4, wherein each brush of the brushes comprise:
a front brush mounted to allow rotation relative to the brush assembly; and
a rear brush mounted separately from the front brush and capable of rotation relative to the brush assembly.

6. The seat rail system of claim 4, wherein each brush of the brushes comprise:
a brush contact portion configured to be in contact with a respective busbar; and
a brush body supported by a brush elastic part so that the brush contact portion is in close contact with the respective busbar.

7. The seat rail system of claim 1, wherein the brush assembly comprises:
a brush bracket;
a brush case mounted on the brush bracket and in which the brushes are rotatably mounted; and
a brush elastic part that elastically supports the brushes.

8. The seat rail system of claim 7, wherein the brush elastic part comprises a compression spring.

9. The seat rail system of claim 7, wherein the brush case has a cable hole through which a cable electrically connected to the brushes is configured to pass.

10. The seat rail system of claim 1, further comprising:
a slide rail mounted on the first lower rail portion and the second lower rail portion, respectively; and
a slide bushing mounted on the brush assembly and configured to move along the slide rail.

11. The seat rail system of claim 10, wherein the brush assembly further comprises:
a slide housing on which the slide bushing is mounted.

12. The seat rail system of claim 1, wherein the brush assembly comprises:
a brush bracket on which the brush case is mounted; and
an upper bracket plate rotatably mounted relative to the upper portion of the brush bracket.

13. The seat rail system of claim 12, wherein the brush assembly further comprises a brush carrier mounted on the upper bracket plate.

14. The seat rail system of claim 12, further comprising a brush connect bracket connecting the upper bracket plate on the first upper rail portion and the upper bracket plate on the second upper rail portion.

15. The seat rail system of claim 14, wherein the upper bracket plate and the brush connect bracket are configured to allow relative rotation.

16. The seat rail system of claim 14, further comprising a connecting pin connecting the upper bracket plate and the brush connect bracket, wherein the brush connect bracket has a hole and a slit into which the connecting pin is inserted.

17. The seat rail system of claim 1, wherein the first lower rail portion and the second lower rail portion include a curved section.

18. The seat rail system of claim 1, further comprising:
a seat assembly mounted on the first upper rail portion and the second upper rail portion, wherein the seat assembly is configured to move along with a movement of the first upper rail portion and the second upper rail portion.

19. The seat rail system of claim 1, further comprising:
an insulator housing, wherein the insulator is configured to be inserted into the insulator housing;
an insulator housing protrusion formed in the insulator housing; and
an insulator protrusion formed in the insulator and pressed into the insulator housing protrusion to prevent separation of the insulator and the inner lower rail.

20. The seat rail system of claim 19, wherein the insulator protrusion elastically supports the busbars and is formed at an end of the insulator to prevent separation of the busbars and the insulator.
